(19) United States
(12) Patent Application Publication
(10) Pub. No.: US 2009/0153494 A1
(43) Pub. Date: Jun. 18, 2009

(54) TOUCH DISPLAY FOR AN APPLIANCE

(76) Inventors: Kevin Scott LAUNDROCHE, Anchorage, KY (US); Eric Scot McAlister, Elizabethtown, KY (US); Nolan A. Polley, Ooltewah, TN (US); Craig Nold, Louisville, KY (US)

Correspondence Address: General Electric Company;GE Global Patent Operation, PO Box 861, 2 Corporate Drive, Suite 648, Shelton, CT, 06484, US

(21) Appl. No.: 11/958,452

(22) Filed: Dec. 18, 2007

(51) Int. Cl. G06F 3/041; G06F 3/048; G01S 13/08

(52) U.S. Cl. 345/173; 715/810; 432/120

(57) ABSTRACT

A display device for an appliance is shown. The display device comprises a touch screen interface and a multi-level menu having reconfigurable virtual buttons.

### BACKGROUND OF THE INVENTION

This invention relates generally to appliances, and more particularly, to an oven or range having touch display controls.

Touch screens are displays that also have the ability to detect the location of touches within the display area. This allows the display to be used as an input device, removing physical buttons such as a keyboard and/or a mouse as the primary input device for interacting with the display's content. Such displays can be attached to computers or as terminals on to networks. Touch screens also have assisted in recent changes in the design of personal digital assistant (PDA), satellite navigation and mobile phone devices, making these devices more usable.

There are a number of types of touch screen technology. A resistive touch screen panel is composed of several layers. The most important are two thin metallic electrically conductive and resistive layers separated by thin space. When some object touches this kind of touch panel, the layers are connected at certain point; the panel then electrically acts similar to two voltage dividers with connected outputs. This causes a change in the electrical current, which is registered as a touch event and sent to the controller for processing. Resistive touch screen panels are generally more affordable then other touch technology. Further, resistive touch screen panels are not affected by outside elements such as dust or water and are the type most commonly used today. However, resistive touch screens are generally less accurate and the layer can be damaged by sharp objects.

Surface Acoustic Wave technology uses ultrasonic waves that pass over the touch screen panel. When the panel is touched, a portion of the wave is absorbed. This change in the ultrasonic waves registers the position of the touch event and sends this information to the controller for processing. Surface wave touch screen panels can be damaged by outside elements. Contaminants on the surface can also interfere with the functionality of the touch screen.

An infrared or IR touch screen panel employs one of two very different methodologies. One method used thermal induced changes of the surface resistance. This method was sometimes slow and required warm hands. Another method is an array of vertical and horizontal IR sensors that detected the interruption of a modulated light beam near the surface of the screen. IR touch screens have the most durable surfaces and are used in many military applications that require a touch panel display. However, the displays are very expensive.

In a strain gauge configuration the screen is spring mounted on the four corners and strain gauges are used to determine deflection when the screen is touched. This technology can also measure the Z-axis. Typically used in exposed public systems such as ticket machines due to their resistance to vandalism.

Optical Imaging utilizes, two or more image sensors that are placed around the edges (typically the corners) of the screen. Infrared backlights are placed in the camera's field of view on the other sides of the screen. A touch shows up as a shadow and each pair of cameras can then be triangulated to locate the touch. This technology is growing in popularity, due to its scalability, versatility, and affordability, especially for larger units.

Dispersive Signal Technology uses sensors to detect the mechanical energy in the glass that occur due to a touch. Complex algorithms then interpret this information and provide the actual location of the touch. The technology claims to be unaffected by dust and other outside elements, including scratches. Since there is no need for additional elements on screen, it also claims to provide excellent optical clarity. Also, since mechanical vibrations are used to detect a touch event, any object can be used to generate these events, including fingers and styli. A downside is that after the initial touch the system cannot detect a motionless finger.

Acoustic Pulse Recognition uses more than two piezoelectric transducers located at positions around the screen to turn the mechanical energy of a touch (vibration) into an electronic signal. This signal is then converted into an audio file, and then compared to preexisting audio profile for every position on the screen. This system works without a grid of wires running through the screen, the touch screen itself is actually pure glass, giving it the optics and durability of the glass out of which it is made. It works with scratches and dust on the screen, with acceptable accuracy. Further, a conductive object is not required to activate the signal. As with the Dispersive Signal Technology system, after the initial touch this system cannot detect a motionless finger.

A capacitive touch screen panel is coated with a material, typically indium tin oxide that conducts a continuous electrical current across the sensor. The sensor therefore exhibits a precisely controlled field of stored electrons in both the horizontal and vertical axes—it achieves capacitance. The human body is also an electrical device that has stored electrons and therefore exhibits capacitance. When the sensor's ‘normal’ capacitance field (its reference state) is altered by another capacitance field, i.e., someone's finger, electronic circuits located at each corner of the panel measure the resultant ‘distortion’ in the sine wave characteristics of the reference field and send the information about the event to the controller for mathematical processing. Capacitive sensors can be touched either with a bare finger or with a conductive device being held by a bare hand. Capacitive touch screens are not affected by outside elements and have high clarity, but complex signal processing electronics increases cost.

FIG. 1 is a front perspective view of a wall oven 100. The doors 104 and 106 permit and impede or prevent access to the interior volumes of the cooking compartments (not shown). The cooking compartments behind doors 104 and 106 are controlled by the interface 110.

FIG. 2 is an example of a known interface 110. Interface 110 typically has a display 112 and controls 114, 116, 118. Display 112 typically shows a series of numbers and/or symbols. Often the numbers are configured to show a time or temperature. The numbers are often in a digital format and illuminated by LEDs or light emitting diodes in a known manner. Segments of each digit are illuminated by LEDs projecting from behind through transparent cutouts. The symbols may prompt for user input or display information about functions, features or the status of the wall oven. Similarly, the symbols are produced by illuminating from behind transparent cutouts of the desired symbol. The features of the display are not configurable, and therefore locations of symbols and numbers are fixed.

Display 110 also contains numeric or feature buttons or keys 114, 116, 118. These buttons are actuated by user pressure at the location of the desired button. While the buttons may be mechanical, resistive touch technology has been more recently used. However, resistive touch technology lacks resolution and therefore the size, location and function of each button is fixed.

### SUMMARY OF THE INVENTION

In an embodiment of the invention a display device for an appliance is shown. The display device comprises a touch screen interface and a multi-level menu having reconfigurable virtual buttons.

In another embodiment for the invention an oven with a display device is shown. The display device further comprises a touch screen interface and a multi-level menu having reconfigurable virtual buttons.

### BRIEF DESCRIPTION OF THE SEVERAL VIEWS OF THE DRAWINGS

The following figures illustrate examples of embodiments of the invention and are not intended to be limiting. The figures are described fully in the detailed description of the invention below.

FIG. 1 is a front perspective view of a known wall oven.

FIG. 2 is a front perspective view of a known display for the wall oven of FIG. 1.

FIG. 3 is a front view of an oven incorporating a reconfigurable touch display of the present invention.

FIG. 4 shows the reconfigurable touch display of FIG. 3 in a “sleep” state.

FIG. 5 shows the reconfigurable touch display of FIG. 3 in a first configuration.

FIG. 6 shows the reconfigurable touch display of FIG. 3 in a second configuration.

FIG. 7 shows the reconfigurable touch display of FIG. 3 in a third configuration.

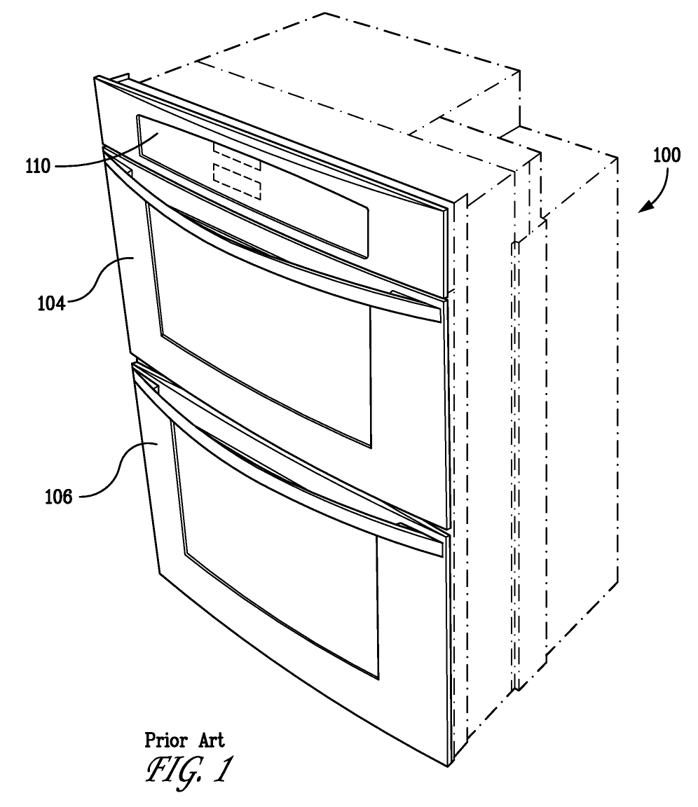

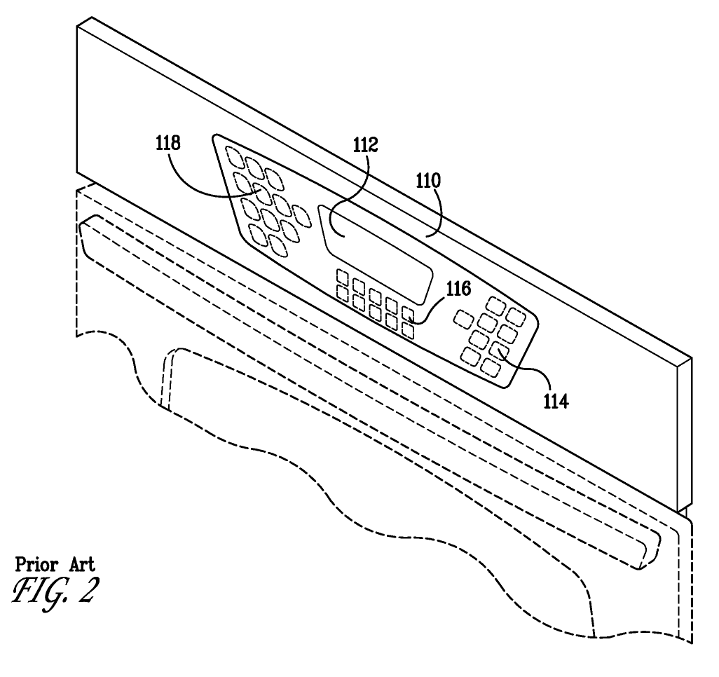

### DETAILED DESCRIPTION OF THE PREFERRED EMBODIMENTS

Embodiments of the invention are described below, with reference to the figures. Throughout the figures, like reference numbers indicate the same or similar components. References to preferred embodiments are for illustration and understanding, and should not be taken as limiting.

It is contemplated that a reconfigurable touch screen appliance user interface, hereinafter interface 300 is disposed in an appliance. For illustration, the appliance is wall oven 200 containing at least one compartment for the cooking of food. However, the appliance may be any household appliance, including but not limited to an oven, a range, a cook top, a refrigerator, a washer, a dryer, a dishwasher, a storage unit for wine or a beverage center. Further it is contemplated that interface 200 may be configured to control more then one appliance or a combination of appliances.

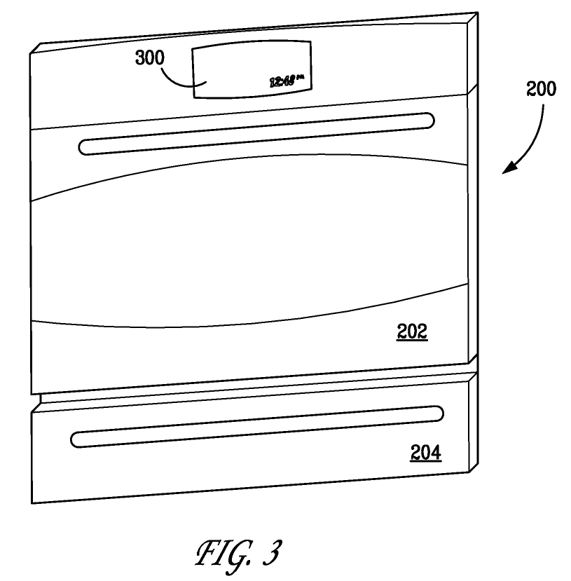

FIG. 3 is a front view of a wall oven 200. The door 202 permits and impedes or prevents access to an interior volume or cooking compartment (not shown) of the oven 200. The cooking compartment behind door 202 is controlled by the interface 300. A second compartment door 204 may be a bake drawer or a second cooking compartment where temperature and other controls are governed by interface 300.

In a preferred embodiment, the interface incorporates a capacitive touch selection unit designed by Quantum Research that adheres to a glass panel and communicates with a logic control device The capacitive touch selection unit may be placed behind up to 5 mm glass. This permits a barrier between it and the user protecting the capacitive glass selection unit and permitting an easily cleaned surface.

The capacitive touch selection unit is optically clear and allows images from an LCD panel to be observed by a user through the capacitive touch selection unit. The capacitive touch selection unit can determine accurately where a user is touching anywhere within the interface area. This accuracy allows the locations of virtual buttons, which normally must be in a consistent and stationary location, to be moved around dynamically or reconfigured. By reconfiguring the virtual buttons on particular menus different features and information may be selected or displayed based on priority or interest to the user as opposed to predefined virtual button locations. Further, a large number of virtual buttons can be placed in menu format within a small area by constantly changing or reconfiguring the interface for specific user selectable options.

Hereinafter, a menu selection device in a wall oven according to the present invention will be explained in detail with reference to the accompanying drawings.

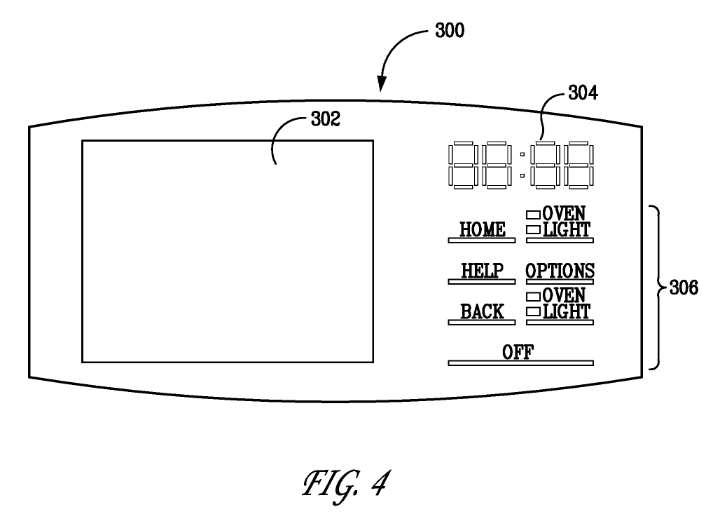

FIG. 4 is an example of the interface 300 in a “sleep” mode. While in the sleep mode, touch screen unit 203 is deactivated. However, static buttons 306 and time display 304 are active. By deactivating touch screen unit 302 electrical efficiency is gained. Further, deactivation of the menu guide unit reduces light output in areas where ambient light needs to be kept to a minimum. A user can activate the menu guide unit by pressing a static button 306. However, the menu guide unit may be activated by other means, including but not limited to proximity sensing around the oven, touch sensitivity remaining active on the touch screen unit 302, or any other known means.

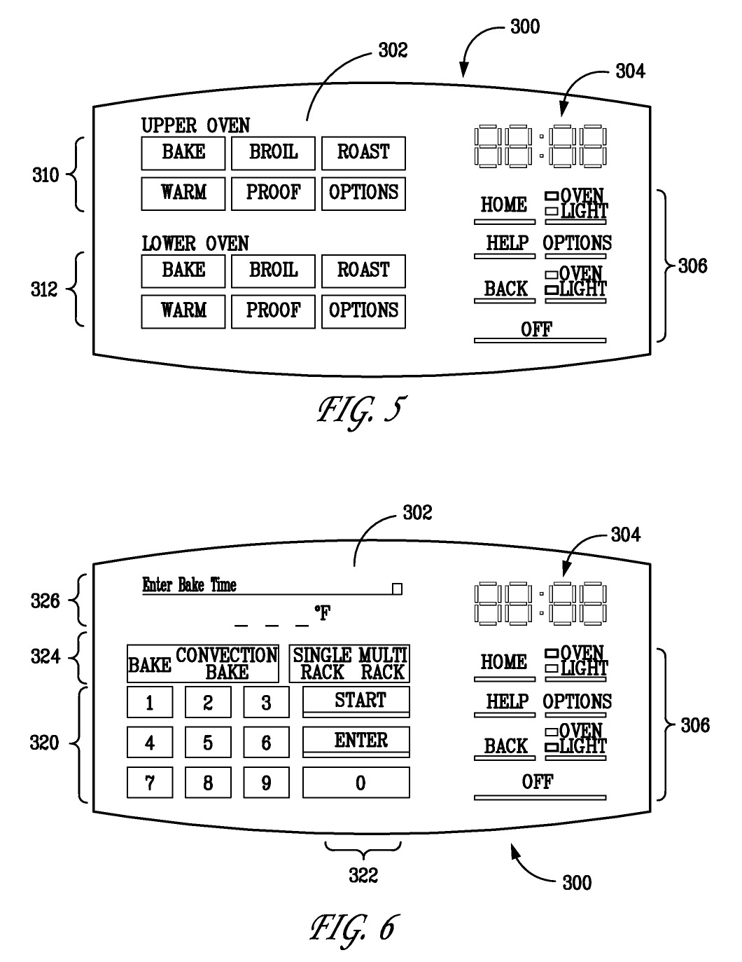

Once active, as shown in FIGS. 5, 6 and 7 the touch screen unit 302 performs display functions of simply displaying data provided thereto and input functions provided by a user. The touch screen unit 302 is constructed in the form of a touch screen. The touch screen unit 302 comprises a menu guide unit 308 and a menu selection unit 309. Menu selection unit 309 can be any known form of touch sensitive technology and is configured as an overlay to menu guide unit 308. Preferably, menu selection unit 309 is a capacity touch sensitive overlay. Menu guide unit 308 is any known display device. Preferably, menu guide unit 308 is an LCD or liquid crystal display.

In particular, the menu guide unit 309 is constructed such that predetermined symbols corresponding to various menus or features can be displayed thereon. Further, when a virtual button or configurable area on menu selection unit 308 corresponding to any one of the predetermined symbols on menu display unit 309 is pressed a specific menu or feature corresponding to the selected symbol is activated.

Referring particularly to FIGS. 5, 6 and 7 specific menu selection names, feature names as well as virtual button sizes and names are for reference only. The menus and features correspond to portions of a program for the wall oven. More specific features and functions may be used as needed for a particular application.

That is, as shown in FIG. 5 an example of a primary menu displaying a series of virtual buttons on interface 302. Each of areas 310 and 312 has two rows of three virtual buttons. The virtual buttons are configured to allow user to select the baking mode for each of the upper and lower ovens.

FIG. 6 shows an example of a secondary menu on interface 302 with reconfigured virtual buttons. Such a menu may have a display area 326 for displaying user-selected information that is inactive to a user's touch. The reconfigured buttons 324, 320 and 322 are of a different size, location, and purpose then the buttons 310 and 312 of FIG. 5. For example, buttons 320 comprise a numeric keypad. As another example buttons 324 permit a user to select additional baking features, such as but not limited to, convection baking or single or multiple rack cooking.

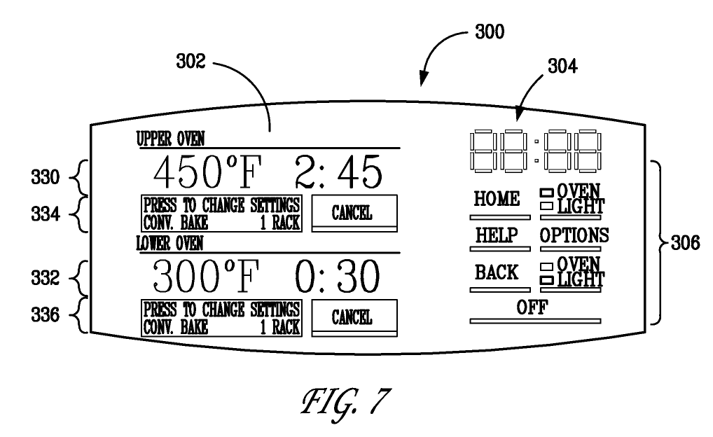

Another example of a secondary menu on interface 302 is shown in FIG. 7. Such a menu may have multiple display areas 330 and 332 for displaying user-selected information or status information of the upper and lower ovens. The display areas 330 and 332 are inactive to a user's touch. Reconfigured buttons 334, 336 are of a different size, location, and purpose then the buttons 310 and 312 of FIG. 5 or the buttons 320, 322 and 324 of FIG. 6. For example, buttons 334 and 336 permit a user to select additional baking features, such as but not limited to, changing to convection baking or canceling the baking cycle.

The process of displaying the virtual buttons onto the touch screen unit 302 and selecting the desired virtual buttons among the displayed virtual buttons in the wall oven 200 according the present invention is know and will not be described in detail.

The exemplary embodiment or embodiments have been described with reference to preferred embodiments. Obviously, modifications and alterations will occur to others upon reading and understanding the preceding detailed description. It is intended that the exemplary embodiments be construed as including all such modifications and alterations insofar as they come within the scope of the appended claims or the equivalents thereof.

1. A display device for an appliance comprising:
a touch screen interface; and
a multi-level menu comprising reconfigurable virtual buttons.

2. The display device of claim 1, wherein touch screen interface comprises a menu selection unit configured between a user and a menu guide unit wherein the menu selection unit is sensitive to the touch of the user.

3. The display device of claim 2, wherein the menu selection unit is a capacitive touch sensitive device.

4. The display device of claim 3, wherein glass is configured between the menu selection unit and the user.

5. The display device of claim 4, wherein the glass is 5 mm thick.

6. The display device of claim 2, wherein the menu guide unit is a liquid crystal display.

7. The display device of claim 1, wherein the appliance is an oven.

8. An oven comprising:
a display device, the display device further comprising:
a touch screen interface; and
a multi-level menu comprising reconfigurable virtual buttons.

9. The oven of claim 8, wherein touch screen interface comprises a menu selection unit configured between a user and a menu guide unit wherein the menu selection unit is sensitive to the touch of the user.

10. The oven of claim 9, wherein the menu selection unit is a capacitive touch sensitive device.

11. The oven of claim 10, wherein glass is configured between the menu selection unit and the user.

12. The oven of claim 11, wherein the glass is 5 mm thick.

13. The oven of claim 9, wherein the menu guide unit is a liquid crystal display.
